(19) United States
(12) Patent Application Publication
(10) Pub. No.: US 2019/0236489 A1
(43) Pub. Date: Aug. 1, 2019

(54) METHOD AND SYSTEM FOR INDUSTRIAL PARTS SEARCH, HARMONIZATION, AND RATIONALIZATION THROUGH DIGITAL TWIN TECHNOLOGY

(71) Applicant: General Electric Company, Schenectady, NY (US)

(72) Inventors: Peter KOUDAL, Niskayuna, NY (US); Walter YUND, Niskayuna, NY (US); Annarita GIANI, Niskayuna, NY (US); Junrong YAN, Niskayuna, NY (US); Dan YANG, Niskayuna, NY (US); Benjamin Edward BECKMANN, Niskayuna, NY (US); Joseph SALVO, Schenectady, NY (US); John William CARBONE, Niskayuna, NY (US); Robert BANKS, Minnetonka, MN (US); Patricia MACKENZIE, Clifton Park, NY (US)

(21) Appl. No.: 15/883,895

(22) Filed: Jan. 30, 2018

(51) Int. Cl. G06N 99/00; G06F 17/30; G06N 5/04

(52) U.S. Cl. CPC G06N 99/005; G06N 5/04; G06F 17/30867

(57) ABSTRACT

An industrial part modeling system may include a digital twin industrial part modeling platform containing a plurality of learning models, each learning model describing characteristics of an industrial part available to be incorporated into an industrial asset. The system may also include an application server platform and a user interface platform to receive an industrial part search or analysis requests from a user. The application server platform may receive information about the industrial part search or analysis request and execute at least one search or analysis algorithm to evaluate learning models in the digital twin industrial part modeling platform. Based on said evaluation, the application server platform may provide an industrial part search or analysis result report to the user. Moreover, the application server platform may automatically arrange for at least one of a search or analysis algorithm and a learning model to be updated based on interaction with the user.

### BACKGROUND

Some embodiments disclosed herein relate to parts for industrial asset and, more particularly, to an industrial part modeling system.

Managing global portfolios of parts for industrial assets and similar products can be challenging for an enterprise. Even advanced companies may have difficulty with respect to the design, sourcing, manufacturing, and servicing of industrial parts in a world-wide supply chain. For example, design engineers often create new parts (and associated part numbers, descriptions, Product Lifecycle Management (“PLM”) entries, etc.) instead of reusing existing parts that are already in use because of the substantial time and effort required to find and reuse the existing design information. Note that the cost of adding new parts to a system can be substantial (e.g., up to $10,000 per new identifier to sustain the part information over the lifecycle of the part), which can make it prohibitively expensive to manage complex products (with thousands of parts)—especially when millions of parts might already exist throughout an enterprise.

Existing approaches to manage industrial parts typically have multiple siloed data stores that stand alone and are not integrated. As a result, the systems generally have incomplete and messy data, across multiple sub-units and companies, etc. and are increasingly incapable of effectively managing and optimizing the use of the design information and manufacturing materials associated with each part. Designers, engineers, service managers, sourcing managers, and manufacturing materials managers may each require different types of information for each part, including design specifics, costs, and availability, in order to perform their roles efficiently. Existing systems, however, may be unable to effectively support these different needs. As a result, part designs may be inefficiently utilized and new parts may be created—at substantial cost—even when existing parts could have been used (incurring unnecessary sourcing costs, inventory costs, Information Technology (“IT”) maintenance costs, etc.).

It would therefore be desirable to provide systems and methods to efficiently and accurately manage industrial asset parts using learning algorithms.

### SUMMARY

According to some embodiments, an industrial part modeling system may include a digital twin industrial part modeling platform containing a plurality of learning models, each learning model describing characteristics of an industrial part available to be incorporated into an industrial asset. The system may also include an application server platform and a user interface platform to receive an industrial part search or analysis request from a user, via a user interface. The application server platform may receive information about the industrial part search or analysis request and execute at least one search or analysis algorithm to evaluate learning models in the digital twin industrial part modeling platform. Based on said evaluation, the application server platform may provide an industrial part search or analysis result report to the user via the user interface platform. Moreover, the application server platform may automatically arrange for at least one of a search or analysis algorithm and a learning model to be updated based on interaction with the user.

Some embodiments comprise: means for receiving, at an application server platform, information about an industrial part search or analysis request submitted by a user via a user interface; means for executing at least one search or analysis algorithm to evaluate learning models in a digital twin industrial part modeling platform, the digital twin industrial part modeling platform containing a plurality of learning models, each learning model describing characteristics of an industrial part available to be incorporated into an industrial asset; based on said evaluation, means for arranging to provide an industrial part search or analysis result report to the user via the user interface platform; and means for automatically arranging for at least one of a search or analysis algorithm and a learning model to be updated based on interaction with the user.

Technical effects of some embodiments of the invention are improved and computerized ways to efficiently and accurately manage industrial asset parts using learning algorithms. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system according to some embodiments.

FIG. 2 is a method that may be associated with parts management in accordance with some embodiments.

FIG. 3 is a high-level block diagram of an industrial part modeling system according to some embodiments.

FIG. 4 is a more detailed version of a web application server layer in accordance with some embodiments.

FIG. 5 is a more detailed version of a digital twin parts model layer according to some embodiments.

FIG. 6 is a more detailed version of a resources layer in accordance with some embodiments.

FIG. 7 is a more detailed version of an industrial part modeling system according to some embodiments.

FIG. 8 illustrates industrial asset parts in accordance with some embodiments.

FIG. 9 is a more detailed industrial part modeling method according to some embodiments.

FIG. 10 illustrates a platform according to some embodiments.

FIG. 11 is a tabular portion of a user search and analysis database according to some embodiments.

FIG. 12 illustrates an industrial part modeling system digital twin part search and analysis display in accordance with some embodiments.

FIG. 13 is a graph illustrating clustering according to some embodiments.

FIG. 14 illustrates a tablet computer displaying a user search and analysis result report interface in accordance with an embodiment of the present technique.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

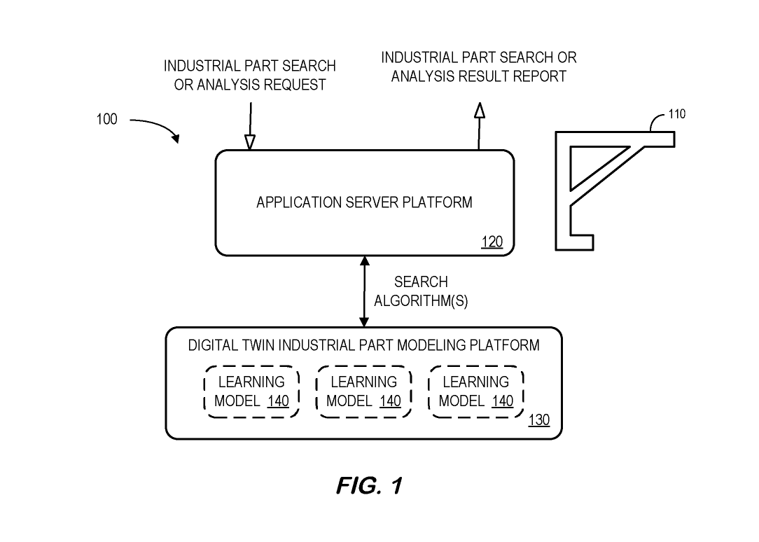

It may generally be desirable to efficiently and accurately manage industrial asset parts using learning models and algorithms. For example, FIG. 1 is a high-level block diagram of a system 100 according to some embodiments. In particular, the system 100 includes an application search or analysis platform 120 that exchanges information with a digital twin industrial part modeling platform 130. The digital twin industrial part modeling platform 130 may be associated with a number of different learning models 140 (e.g., each representing a digital twin of a physical industrial asset part 110) and might be, for example, implemented using a Personal Computer (“PC”), laptop computer, a tablet computer, a smartphone, an enterprise server, a server farm, an Application Specific Interface Circuit (“ASIC”), a single board microcontroller card, and/or a database or similar storage devices. According to some embodiments, an “automated” digital twin industrial part modeling platform 130 may automatically facilitate industrial asset part management. As used herein, the term “automated” may refer to, for example, actions that can be performed with little (or no) intervention by a human.

As used herein, devices, including those associated with the digital twin industrial part modeling platform 130 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The digital twin industrial part modeling platform 130 may store information into and/or retrieve information from data stores (e.g., containers local to the platform 130 and/or other data stores). The data stores might, for example, store electronic records representing industrial assets, industrial parts, etc. The data stores may be locally stored or reside remote from the digital twin industrial part modeling platform 130. Although a single digital twin industrial part modeling platform 130 is shown in FIG. 1, any number of such devices may be included and may be configured in a centralized, distributed, or cloud-based configuration. Moreover, various devices described herein might be combined according to embodiments of the present invention. For example, in some embodiments, the digital twin industrial part modeling platform 130, the application server platform 120, and/or other devices might be co-located and/or may comprise a single apparatus.

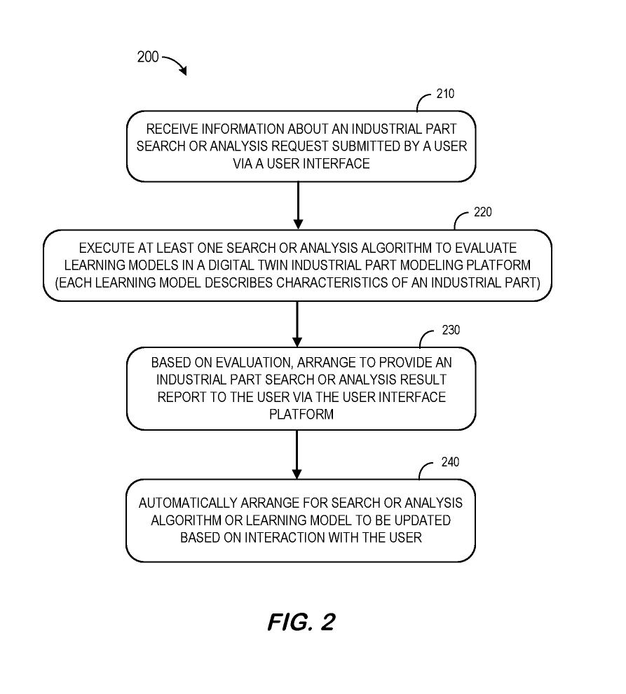

According to some embodiments, the application server platform 120 may receive an industrial part search or analysis request from a user. Responsive to the request, one or more search or analysis algorithms may be executed and an industrial part search or analysis result report may be provided to the user (e.g., indicating one or more existing industrial parts that might be suitable for a particular task). In this way, the system 100 may efficiently and accurately manage industrial asset parts using learning models or algorithms 140. For example, FIG. 2 illustrates a method 200 that might be performed by the digital twin industrial part modeling platform 130 and/or other elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 210, an application server platform may receive information about an industrial part search or analysis request submitted by a user via a user interface. For example, the search or analysis request might be associated with key words, a search image, a tree representation of a Bill Of Materials (“BOM”) structure, etc. According to some embodiments, the search or analysis request might be associated with an adjustment to a prior search or analysis (e.g., a change to a search or analysis term after the user reviews a result report of the prior search or analysis), part profile data information, key words in specific fields, etc.

At 220, the system may execute at least one search or analysis algorithm to evaluate learning models in a digital twin industrial part modeling platform. The digital twin industrial part modeling platform may, for example, contain a plurality of learning models, each learning model describing “characteristics” of an industrial part available to be incorporated into an industrial asset. As used herein, a “characteristic” might include, by way of examples, a part identifier, a part name, a part description, a part image (e.g., a picture or Computer Aided Design (“CAD”) file), design details, a part geometry (e.g., a part shape), cost information, supplier information, geographic location data, a manufacturing technique (e.g., an additive manufacturing technique), a manufacturing material, part availability, related bills of material, related drawings, quality control data (e.g., reliability information), etc.

The evaluation of learning models performed at 220 might be associated with multiple search or analysis algorithms of various types, including a string matching algorithm, an index algorithm, a semantic algorithm, a knowledge base algorithm, a similarity algorithm, a BOM, a geometric data algorithm, a social network data algorithm (indicating what other users have done in connection with related searches), an identity algorithm, a part application algorithm, a comparability algorithm, etc. According to some embodiments, a search or analysis algorithm may be associated with artificial intelligence, a process clustering, an associative search, a cognitive process, machine intelligence, image recognition, natural language processing, an identity search, a pat application search, a comparability search, feature extraction, etc. Moreover, the search or analysis algorithm might be based at least in part on a user role. For example, different types of searches might be performed for a part requisition role, design engineer, expert, manager (e.g., a sourcing manager, a service manager, a manufacturing materials manager, or an inventory manager), a manufacturing role, etc.

Based on said evaluation, at 230 the system may arrange to provide an industrial part search or analysis result report to the user via the user interface platform. According to some embodiments, the industrial part search or analysis result report may include a customized ranking, a score, cost data, availability data (e.g., “how soon can the part be delivered”), identical, similar, comparable parts, features extracted, combined and integrated results from multiple components, etc.

At 240, the system may automatically arrange for at least one of a search or analysis algorithm and a learning model to be updated based on interaction with the user. For example, the update to the search or analysis algorithm or learning model might be based on “feedback information” received from the user in response to the industrial part search or analysis result report. As used herein, the phrase “feedback information” might refer to user comments, user answers to automatically generated questions, user buying behavior, a user vote, user activity information, contextual information about users, communities, or networks, etc.

In addition to responding to user search or analysis requests, some embodiments may facilitate a rationalization process to combine multiple learning models into a single learning model. For example, it might be determined that five different learning models are in fact associated with identical parts. As a result, the rationalization process might merge the data from these models into a single model. Note that learning models may, according to some embodiments, be automatically created based on a wide variety of information available to an enterprise and might be associated with knowledge extraction, manufacturing documents, a part specification, text documents, CAD documents, web search results, a parts semantic index, parts clustering, parts classification, part association, graph and networking processes, historical data (e.g., how long did this type of part typically last until it needed to be replaced?), internal data, external data, structured data, unstructured data, etc.

Thus, some embodiments described herein may create a learning digital twin system of each and every part across a company (or a set of companies), which may enable designers, managers, sourcing, material managers, and/or engineers to automatically search, rationalize, and find the best part for a given purpose at the lowest economic cost to the company. By using advanced artificial intelligence and search technology, some embodiments may permit the automatic amalgamation of disparate, disjoined, “dirty” data and systems to be used to create a learning knowledge base. User interaction and automatic interaction with multiple systems of data may provide continuous learning to constantly improve the information available to each user in the system. The learning may include not only data and information about parts, products, and subsystems, but may also include contextual information about users, communities, networks. All of this may let the system infer ever-more insightful information for users.

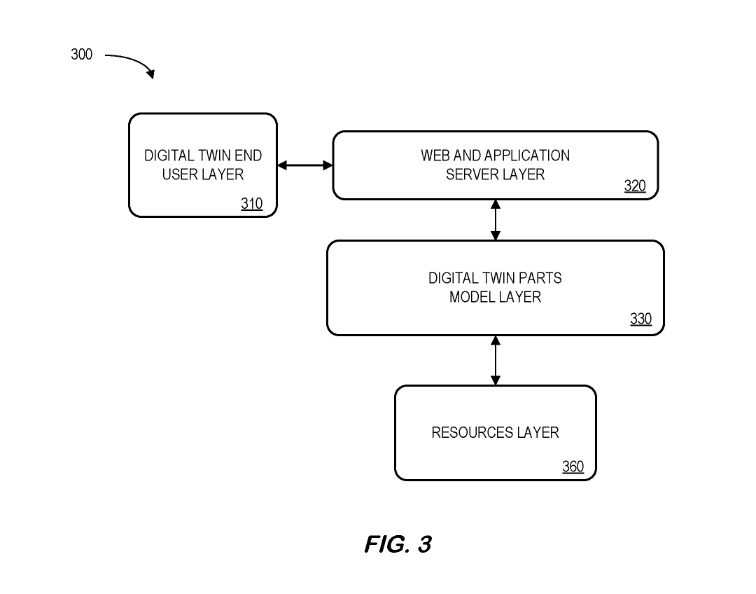

FIG. 3 is a high-level block diagram of an industrial part modeling system 300 according to some embodiments. In particular, a user may interact with a digital twin end user layer 310 to access a digital twin parts model layer 330 (created from a resources layer 360) via a web and application server layer 320. Note that the digital twin end user layer 310 may be tailored based on different roles of different users. For example, the system 300 may serve different user roles with a personalized web-accessible user interface. Different users may get different start pages based on his or her role (e.g., engineer, sourcing expert, sourcing manager, or service manager) and/or a customized digital twin for each user and user type. The digital twin end user layer 310 might be accessed, for example, through web browsing tools (Chrome, Internet Explorer, Bing, Firefox, etc.) and features may be built into the application based on backend analytics and user experience design, such as” “type-ahead” and/or auto-completion features based on analysis of the parts in a parts database; a tree representation of a BOM structure; and a search-compare-checkout style of standard shopping process in the part search or analysis process so that the industry users can leverage the most up-to-date knowledge.

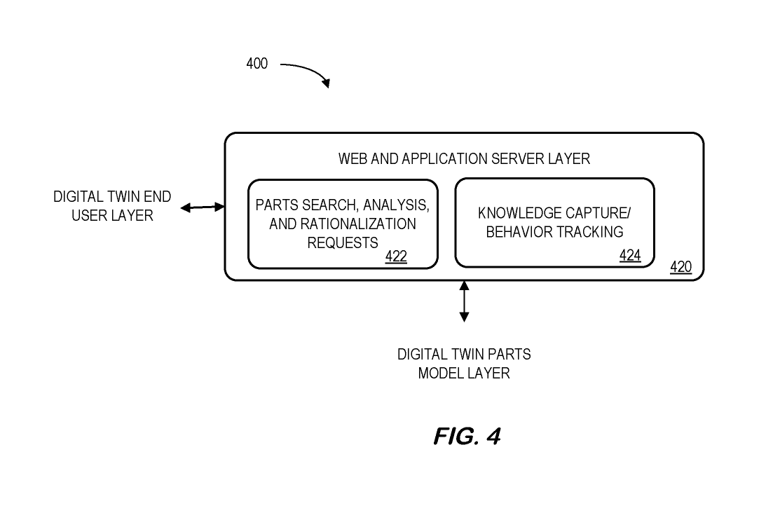

The web and application server layer 320 ma combine multiple integrated or separate algorithms and knowledge extraction methods to provide services to the end user requests and experience. FIG. 4 is a more detailed version of a system 400 with a web application server layer 420 in accordance with some embodiments. The web application server layer 420 may, according to some embodiments, handle parts search, analysis, and rationalization requests 422 and knowledge capture/behavior tracking 424. The parts search, analysis, and rationalization requests 422 may combine multiple algorithms and methods to provide the most valuable answer to a user's parts search or analysis request. The functions might include, for example, invoking appropriate components based on the user's request, combining and integrating the return results from the multiple components, providing a customized ranking when there are multiple answers (e.g., search results) for a user's request, and returning combined results to the user. The parts search, analysis, and rationalization requests 422 might also provide questions to the user. In this case, the user may provide an answer or comment to the question or vote (e.g., appropriate search result or non-appropriate search result) to enhance the knowledge base for better search or analysis outcomes in the future.

The knowledge capture/behavior tracking 424 might record various types of data, such as by: capturing user knowledge based on answers to questions provided by the system 400, recording comments provided by the user for parts and usage of the systems; and tracking a user's “buying” behaviors of the parts (e.g., historical buying behavior, the parts users typically selected together, and the replacement of particular old parts with specific new ones). The knowledge capture/behavior tracking 424 might also record a user's browsing behavior (e.g., which web sites did the user visit, what web pages on those web sites did the user visit, how long a user stayed looking at each web page, and his or her activities while interactive with a web page).

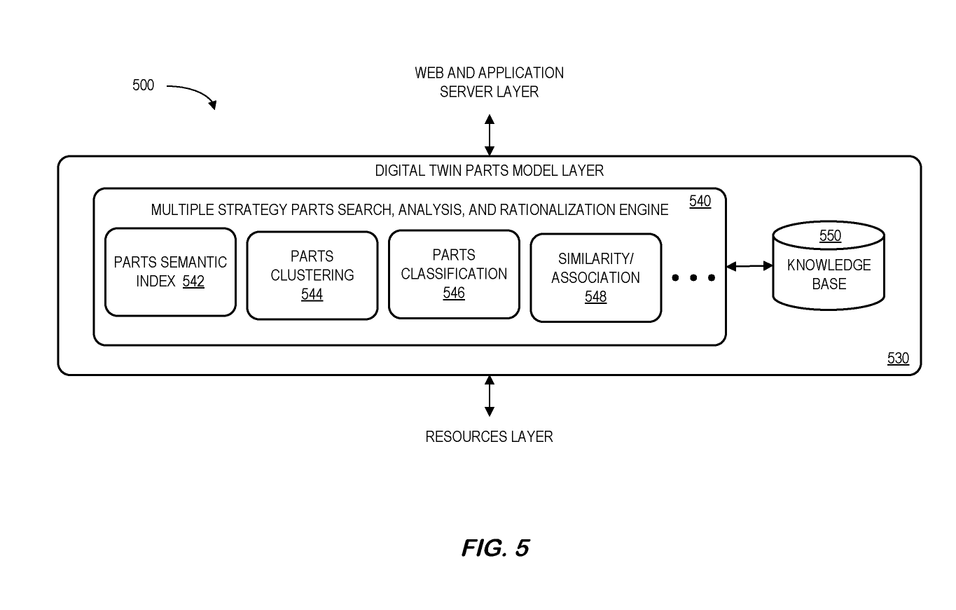

Referring again to FIG. 3, the digital twin parts model layer 330 may provide a combination of different evolving digital twin advanced learning models to describe different aspects of each part. For example, FIG. 5 is a more detailed version of a system 500 with a digital twin parts model layer 530 according to some embodiments. Note that a multiple strategy parts search, analysis, and rationalization engine 540 might exchange data with a knowledge base 550 to execute various models. The knowledge base 550 might comprise, for example, a repository that keeps prior knowledge (associated with a semantic model, taxonomy, BOM templates, etc.) as well as knowledge captured when a user interacts with the system 500 (user comments, answers to the questions, votes, web page behaviors, etc.).

The models associated with the digital twin parts model layer 530 might include, for example, a parts semantic index 542 that applies a semantic model in the industry parts domain to acquire, preprocess, and index text information describing the parts. In this way, data can be captured so that it can be searched in a flexible and efficient way to identify a specific part. The parts semantic index 542 might be used, for example, to search and/or analyze the parts leverage synonyms and/or perform rule based inferences. According to some embodiments, the models might include parts clustering 544 to enable discovery of similar parts based on system discovered or user specified measures (e.g., specific measurements of each part, price, availability, and similar information). Note that “similar” parts might also include “identical” parts. The models might also include parts classification 546 to enable discrimination of one type of part from another type of part based on labeled samples of the historical part information. As another example, the models might include part association to utilize association analysis to identify the parts that a user (or other users) frequently brought together or parts that are frequently associated with a single BOM. As still another example, the models might include a graph and networking model that uses network data to record and track linkages associated with parts and/or users associated with parts so that some common patterns may be extracted and used to recommend additional information (e.g., when a user is working with part search, analysis, and identification).

Note that the digital twin parts model layer 530 may use initial models when the system 500 is first installed (e.g., based on existing historical data) which can then be updated as users interact with the system 500. That is, the system 500 may incorporate a feedback loop and constant learning mechanism. When enough data is captured in the knowledge base 550, re-evaluations may be performed for the models and algorithms used in the system 500. If necessary, re-learning and/or re-training of the models may be performed based on historical data and new data connected from interactions with the user (and, potentially, other users). When a new model is trained, it can be deployed in the digital twin parts model layer 530. A model evaluation, training, and deployment mechanism may enhance the accuracy and effectiveness of the system 500.

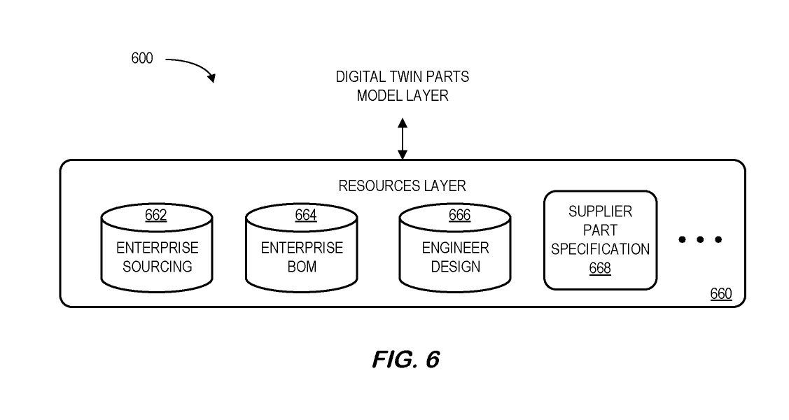

Referring again to FIG. 3, the digital twin parts model layer 330 may interact with the resources layer 360 such that multiple data resources may be used by the system 300 to establish initial models (and the system 300 may drill down for more information if appropriate). FIG. 6 is a more detailed version of a system 600 with a resources layer 660 in accordance with some embodiments. The resource layer 600 may include multiple internal structured data stores, such as those associated with enterprise sourcing 662, enterprise BOM 664, and engineer design 666. The resource layer 660 may also include internal unstructured data, such as engineering drawings of the parts, etc. According to some embodiments, the resource layer 660 may further include external structured and unstructured data, such as a part specification 668 provided by a vendor or supplier, a part description taken from a vendor's documentation or web site, other information from web searches, etc.

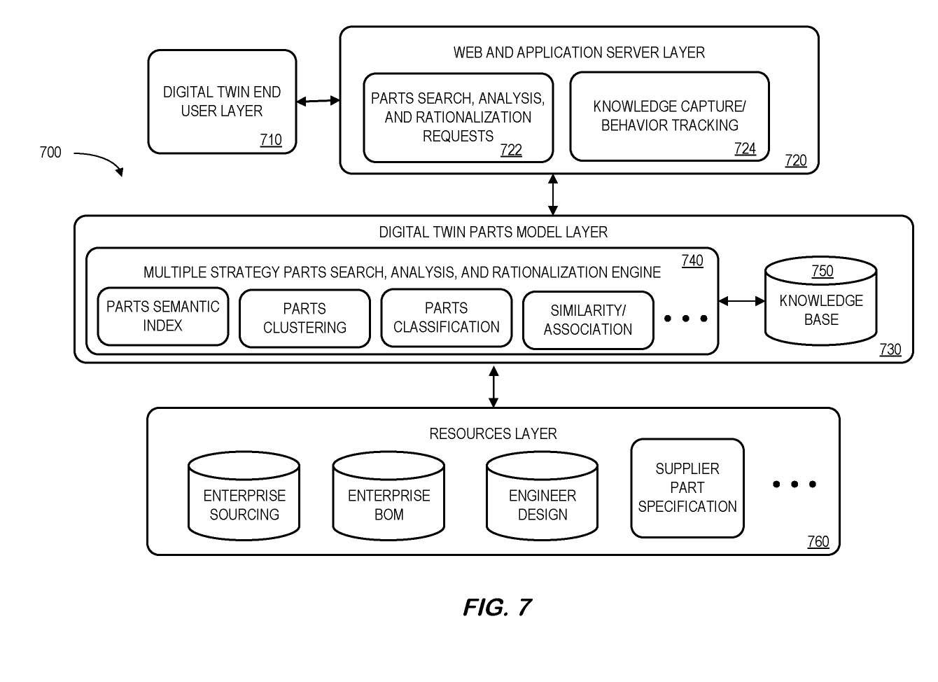

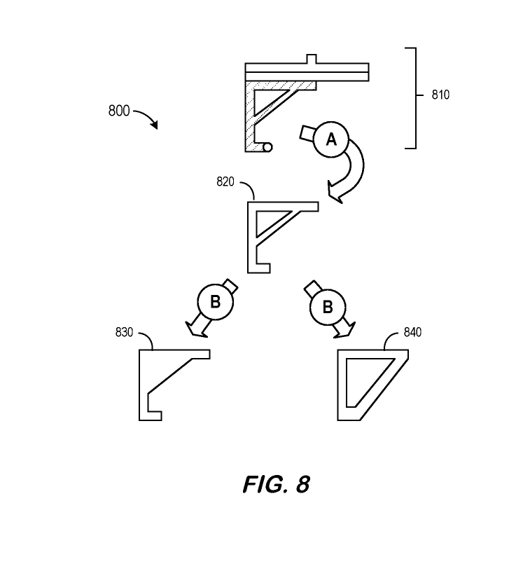

FIG. 7 is a more detailed version of an industrial part modeling system 700 according to some embodiments. As before, a digital twin end user layer 710 interacts with a web application server layer 720 (including parts search, analysis, and rationalization requests 722 and knowledge capture/behavior tracking 724). A digital twin parts model layer 730 includes a multiple strategy parts search, analysis and rationalization engine 740 and knowledge base 750. The digital twin parts model layer 730 may include an advanced learning model for each industrial part created based on information from a resources layer 760. The system 700 may then be used to locate industrial parts potentially of interest to a user. For example, FIG. 8 illustrates industrial asset parts 800 in accordance with some embodiments. In particular, an industrial asset item 810 (e.g., associated with an engine, turbine, electrical system, etc.) may be built using many components and sub-components, including a particular part 820 (illustrated with cross-hatching within the item 810) of interest to a user at (A). The system may automatically utilize a digital twin learning model of the part 820 (and other learning models, search or analysis algorithms, etc.) to location at (B) similar parts 830, 840 that might be of interest to the user (e.g., because the behave in similar ways) depending on various characteristics of the part 820 (cost, availability, strength, reliability, additive manufacturing method, material, physical properties, etc.).

Note that some types of parts may be associated with characteristics that frequently change. For example, an additive manufacturing platform might utilize an additive manufacturing printer associated with three-dimensional printing. In this case, the characteristics might be associated with a printer model or software version, a resolution, a powder, a deadline, material specifications, process conditions, etc. As used herein, the phrase “additive manufacturing” may refer to various types of three-dimensional printing, including, for example, those described in the American Society for Testing and Materials (“ASTM”) group “ASTM F42—Additive Manufacturing” standards. These include vat photopolymerisation (using a vat of liquid photopolymer resin), material jetting (where material is jetted onto a build platform), binder jetting (e.g., using a powder based material and a binder), material extrusion such as Fuse Deposition Modelling (“FDM”). powder bed fusion (e.g., Direct Metal Laser Sintering (“DMLS”), Electron Beam Melting (“EBM”), etc.), a sheet lamination (including Ultrasonic Additive Manufacturing (“UAM”) and Laminated Object Manufacturing (“LOM”)), and Directed Energy Deposition (“DED”). Because parts associated with additive manufacturing techniques may frequently be changed or adjusted, the industrial part modelling systems described herein may provide for a substantial improvement when users search for similar parts and analyze results.

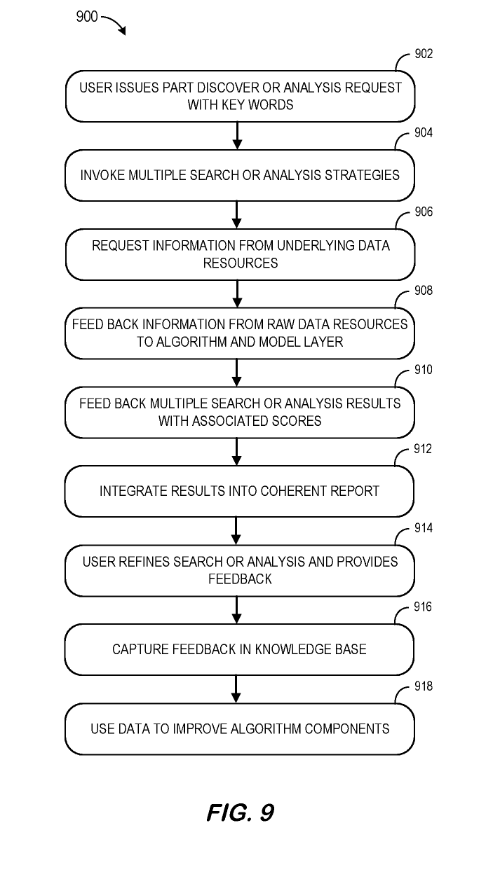

Referring again to FIG. 7, the layers of the system 700 functional architecture may work coherently to create an efficient part search and rationalization system, including a feedback loop that may improve the accuracy and efficacy of the system 700 as more interactions are captured with users. For example, FIG. 9 is a more detailed industrial part modeling method 900 according to some embodiments.

At 902, a user may issue a part discovery or analysis request by entering some known key words into an interactive graphical interface. At 904, a parts search, analysis, and rationalization component gets the request and invokes a multi-search and/or multi-analysis strategy. The multi-search strategy might include some or all of: performing a semantic search to discover relevant parts and identify the most relevant ones based on some thresholds and filters; applying clustering models to identify similar parts; applying classification models to score found parts; applying association models to identify associated parts; applying network models to identify associated parts and other users who may purchase, have comments about, or use the parts; and combining the information to get an appropriate raking and scoring based on predefined models or algorithms. Note that the multi-search strategy of 904 might incorporate information from the knowledge base. At 906, if needed, additional detailed information from underlying data resources may be automatically requested and retrieved as a new input. At 908, information from the raw data resources may be fed back to the algorithm and model layer (e.g., to support the multi-search strategy of 904).

At 910, multiple search or analysis results with scores may be fed back to the parts search and rationalization components. At 912, the parts search, analysis, and rationalization components may integrate the results into a coherent report/user interface with combined relevance scores to be reported to the user.

After reviewing the result report, the user can perform refinements of his or her search or analysis and/or provide some feedback to the system at 914. At 916, this user feedback may be captured in the knowledge base. At 918, the new data is used to update algorithm and/or model components as appropriate. For example, when pre-defined thresholds are satisfied, the system may trigger re-learning and/or re-training methods to update the models. In some cases, human intervention may be necessary for substantial model changes to verify that the changed model will meet requirements. Finally, the new models may be deployed to the system to enhance the performance of the system (e.g., to improve search or analysis accuracy and/or provide additional relevant information about parts).

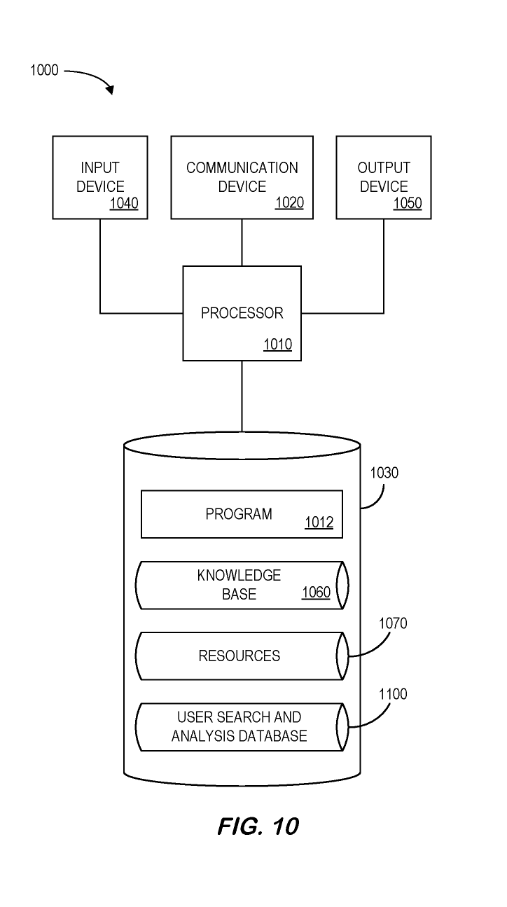

Embodiments described herein may comprise a tool that facilitates industrial part management and may be implemented using any number of different hardware configurations. For example, FIG. 10 illustrates a platform 1000 that may be, for example, associated with the systems 100, 700 of FIGS. 1 and 7, respectively (as well as other systems described herein). The platform 1000 comprises a processor 1010, such as one or more commercially available Central Processing Units (“CPUs”) which may be in the form of one-chip microprocessors, coupled to a communication device 1020 configured to communicate via a communication network (not shown in FIG. 10). The communication device 1020 may be used to communicate, for example, with one or more user devices, web browsers, etc. Note that communications exchanged via the communication device 1020 may utilize security features, such as those between a public internet user and an internal network of an insurance enterprise. The security features might be associated with, for example, web servers, firewalls, and/or PCI infrastructure. The platform 1000 further includes an input device 1040 (e.g., a mouse and/or keyboard to enter information about an industrial asset, a part, a learning model, etc.) and an output device 1050 (e.g., to output search or analysis results, system status reports, administrative logs, etc.).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1012 and/or network security service tool or application for controlling the processor 1010. The processor 1010 performs instructions of the program 1012, and thereby operates in accordance with any of the embodiments described herein. For example, the processor 1010 may execute learning models, each learning model describing characteristics of an industrial part available to be incorporated into an industrial asset. The processor 1010 may also include an application server platform and a user interface platform to receive an industrial part search or analysis request from a user and execute at least one search or analysis algorithm to evaluate learning models. Based on the evaluation, the processor 1010 may provide an industrial part search or analysis result report to the user. Moreover, the processor 1010 may automatically arrange for at least one of a search or analysis algorithm and a learning model to be updated based on interaction with the user.

The program 1012 may be stored in a compressed, uncompiled and/or encrypted format. The program 1012 may furthermore include other program elements, such as an operating system, a database management system, and/or device drivers used by the processor 1010 to interface with peripheral devices.

As used herein, information may be “received” by or “transmitted” to, for example: (i) the platform 1000 from another device; or (ii) a software application or module within the platform 1000 from another software application, module, or any other source.

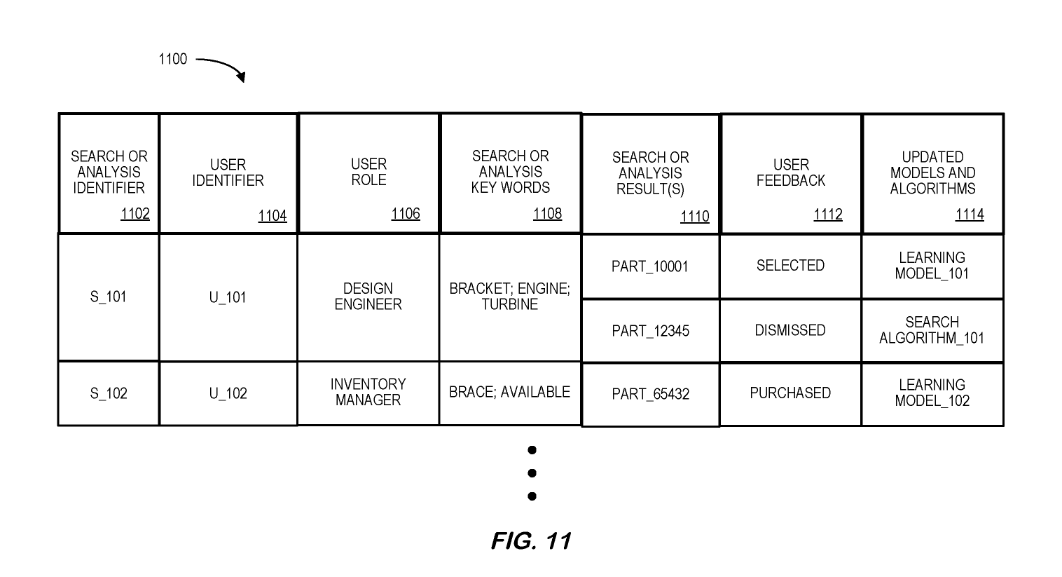

In some embodiments (such as shown in FIG. 10), the storage device 1030 further stores a knowledge base 1060, resources 1070, and a user search and analysis database 1100. An example of a database that might be used in connection with the platform 1000 will now be described in detail with respect to FIG. 11. Note that the database described herein is only an example, and additional and/or different information may be stored therein. Moreover, various databases might be split or combined in accordance with any of the embodiments described herein. For example, knowledge base 1060 and resources 1070 might be combined and/or linked to each other within the program 1012.

Referring to FIG. 11, a table is shown that represents the user search and analysis database 1100 that may be stored at the platform 1000 in accordance with some embodiments. The table may include, for example, entries identifying industrial part search or analysis requests that have been received from users. The table may also define fields 1102, 1104, 1106, 1108, 1110, 1112, 1114 for each of the entries. The fields 1102, 1104, 1106, 1108, 1110, 1112, 1114 may, according to some embodiments, specify: a search or analysis identifier 1102, a user identifier 1104, a user role 1106, search or analysis key words 1108, search or analysis results 1110, user feedback 1112, and updated models and algorithms 1114. The user search and analysis database 1100 may be created and updated, for example, based on information electrically received from remote user devices, search or analysis algorithms, etc.

The search or analysis identifier 1102 may be, for example, a unique alphanumeric code identifying an industrial part search or analysis request received by the system. The user identifier 1104 and user role 1106 may identify who submitted the search or analysis request and, in some embodiments, may be used to interpret the search or analysis request and/or to customize search or analysis results for the user. The search or analysis key words 1108 may include words, phrases, tags, etc. entered by the user as being associated with the industrial part he or she is attempting to locate or analyze. The search or analysis results 1110 may include one or more part identifiers and/or additional information about the parts (including, for example, an automatically calculated relevance score, ranking, etc.). The user feedback 1112 might comprise an answer to a question, a vote, a user action (e.g., selection of one of the search or analysis results 1110). The user feedback 1112 may then be used to improve elements of the system as indicated by the updated models and algorithms 1114.

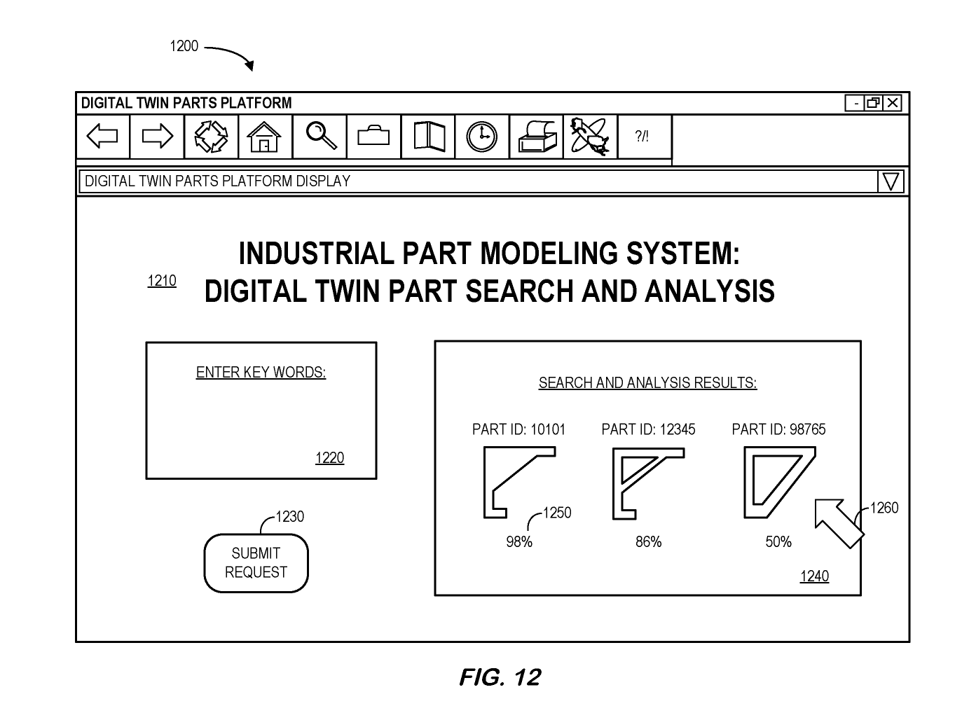

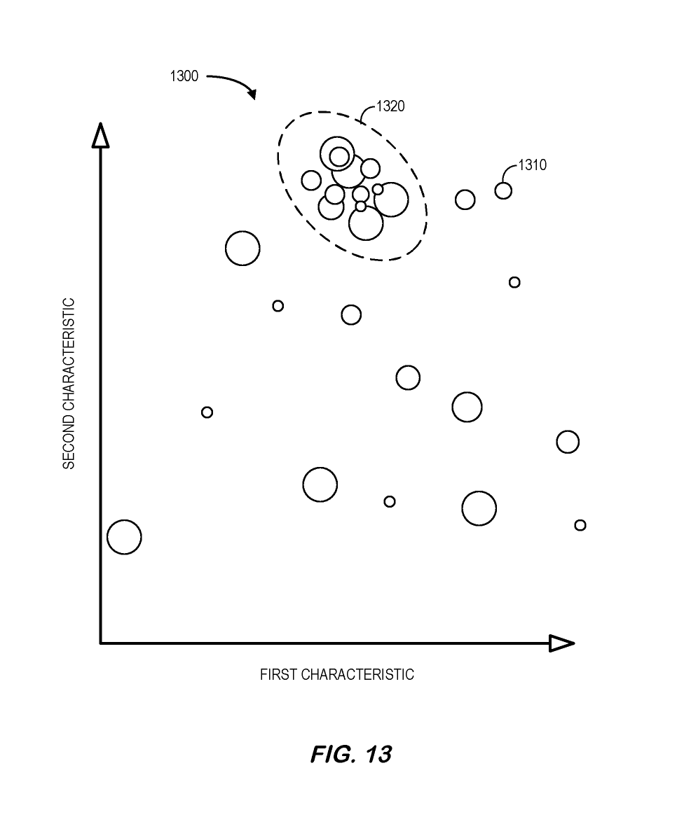

FIG. 12 illustrates an industrial part modeling system digital twin part search and analysis display 1200 in accordance with some embodiments. The display 1200 includes an interactive user interface 1210 with a data entry portion 1220 that can be utilized by a user to provide search and/or analysis terms associated with an industrial asset part (e.g., key words, images, or part characteristics). Upon selection of a “Submit Request” icon 1230, the system may automatically execute multiple search or analysis algorithms to locate or analyze one or more learning models that best fit the entered terms. These results may then be displayed in a search and analysis result portion 1240 of the display 1200 (e.g., along with a percentage score 1250 indicating how likely it is that each result will be of interest to the user). The user may select one of the results with a touchscreen or computer mouse pointer 1260. The system may then utilize the selection of one of the results by the user to update algorithms and/or learning models to improve future results. For example, the system might make it more (or less) likely that an industrial part will be included in a “cluster” of parts of a certain type (because certain users often or rarely end up selecting that particular part). FIG. 13 is a graph 1300 illustrating clustering according to some embodiments. The graph 1300 plots parts 1310 in accordance with a first characteristic and a second characteristic. Although two characteristics are illustrated in FIG. 13, note that parts might be associated with any number of characteristics. Moreover, the diameter of the marker size for each plotted part 1310 might reflect additional information about that part (popularity, reliability, cost, etc.). The system may then look for patterns in the graph 1300 so that parts sharing similar characteristics may be grouped together in a “cluster” of parts 1320 (which can be used to improve search or analysis results or to consolidate identical or similar parts during a rationalization process).

Thus, embodiments may provide a distributed and modular system that enables unlimited scaling of the technology components described herein. The modular architecture may also allow for new components to be added to the system as technologies progress and new use cases are added to the platform. This architecture may enable low-cost development and rapid deployment in increments to match commercial opportunities. Because of the distributed architecture, it may be easy to collaborate with other parties, companies, suppliers, customers, etc. around the world to keep improving the platform over time.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

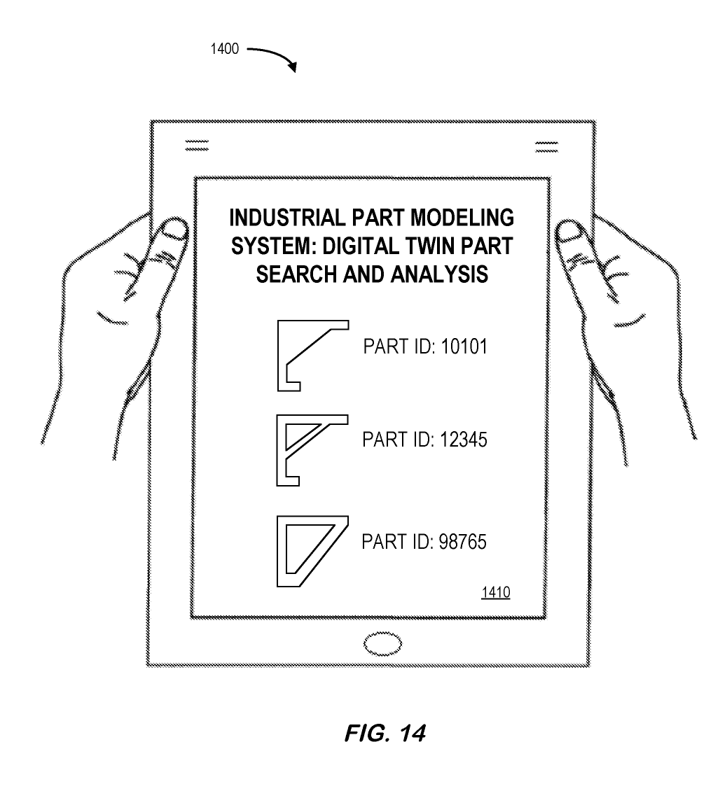

Although specific hardware and data configurations have been described herein, note that any number of other configurations may be provided in accordance with embodiments of the present invention (e.g., some of the information described herein may be combined or stored in external cloud-based and/or third-party systems). Moreover, although embodiments have been described with respect to particular types of industrial assets and parts, note that embodiments might be associated with other types of parts including dams, automobiles, self-driving vehicles, airplanes, etc. Similarly, the displays shown and described herein are provided only as examples, and other types of displays and display devices may support any of the embodiments. For example, FIG. 14 illustrates a tablet computer 1400 displaying a user search and analysis result report interface 1410 in accordance with an embodiment of the present technique. Selection of a part on the interface 1410 may result in additional details about that part being displayed (as well as being used to automatically update and improve various search or analysis algorithms, advanced learning models, etc.).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. An industrial part modeling system, comprising:
a digital twin industrial part modeling platform containing a plurality of learning models, each learning model describing characteristics of an industrial part available to be incorporated into an industrial asset;
a user interface platform to receive an industrial part search or analysis request from a user via a user interface; and
an application server platform, coupled to the digital twin industrial part modeling platform and the user interface, adapted to:
receive information about the industrial part search or analysis request,
execute at least one search or analysis algorithm to evaluate learning models in the digital twin industrial part modeling platform,
based on said evaluation, arrange to provide an industrial part search or analysis result report to the user via the user interface platform, and
based on interaction with the user, automatically arrange for at least one of a search or analysis algorithm and a learning model to be updated.

2. The system of claim 1, wherein the characteristics of an industrial part include at least one of: (i) a part identifier, (ii) a part name, (iii) a part description, (iv) a part image, (v) design details, (vi) a part geometry, (vii) cost information, (viii) supplier information, (ix) geographic location data, (x) a manufacturing technique, (xi) a manufacturing material, (xii) part availability, (xiii) related bills of material, (xiv) related drawings, and (xv) quality control data.

3. The system of claim 1, wherein the search or analysis request is associated with at least one of: (i) key words, (ii) a search image, (iii) a tree representation of a bill of materials structure, (iv) an adjustment to a prior search or analysis, (v) part profile information, and (vi) key words in specific fields.

4. The system of claim 1, wherein the evaluation of learning models is associated with a plurality of search or analysis algorithms, including at least one of: (i) a string matching algorithm, (ii) an index algorithm, (iii) a semantic algorithm, (iv) a knowledge base algorithm, (v) a similarity algorithm, (vi) a bill of materials algorithm, (vii) a geometric data algorithm, (viii) a social network data algorithm, (ix) an identity algorithm, (x) a part application algorithm, and (xi) a comparability algorithm.

5. The system of claim 1, wherein a search or analysis algorithm is associated with at least one of: (i) artificial intelligence, (ii) a process clustering, (iii) an associative search, (iv) a cognitive process, (v) machine intelligence, (vi) image recognition, (vii) natural language processing, (viii) an identity search, (ix) a part application search, (x) a comparability search, and (xi) feature extraction.

6. The system of claim 1, wherein the industrial part search or analysis result report includes at least one of: (i) a customized ranking, (ii) a score, (iii) cost data, (iv) availability data, (v) identical, similar, comparable parts, (vi) features extracted, and (vii) combined and integrated results from multiple components.

7. The system of claim 1, wherein the search or analysis algorithm is based at least in part on a user role, including user rolls associated with at least one of: (i) a part requisition role, (ii) design engineer, (iii) expert, (iv) engineering manager, (v) sourcing manager, (vi) service manager, (vii) manufacturing materials manager, (viii) inventory manager, and (ix) a manufacturing role.

8. The system of claim 1, wherein a rationalization process is executed to combine multiple learning models into a single learning model.

9. The system of claim 1, wherein the update to the search or analysis algorithm or learning model is based on feedback information received from the user in response to the industrial part search or analysis result report.

10. The system of claim 9, wherein the feedback information includes at least one of:
(i) user comments, (ii) user answers to automatically generated questions, (iii) user buying behavior, (iv) a user vote, (v) user activity information, and (vi) contextual information about users, communities, or networks.

11. The system of claim 1, wherein a learning model of an industrial part is automatically created using at least one of: (i) knowledge extraction, (ii) manufacturing documents, (iii) a part specification, (iv) text documents, (v) computer aided design documents, (vi) web search results, (vii) a parts semantic index, (viii) parts clustering, (ix) parts classification, (x) part association, (xi) graph and networking processes, (xii) historical data, (xiii) internal data, (xiv) external data, (xv) structured data, and (xvi) unstructured data.

12. A computer-implemented industrial part modeling method, comprising:
receiving, at an application server platform, information about an industrial part search or analysis request submitted by a user via a user interface;
executing at least one search or analysis algorithm to evaluate learning models in a digital twin industrial part modeling platform, the digital twin industrial part modeling platform containing a plurality of learning models, each learning model describing characteristics of an industrial part available to be incorporated into an industrial asset;
based on said evaluation, arranging to provide an industrial part search or analysis result report to the user via the user interface platform; and
automatically arranging for at least one of a search or analysis algorithm and a learning model to be updated based on interaction with the user.

13. The method of claim 12, wherein the characteristics of an industrial part include at least one of: (i) a part identifier, (ii) a part name, (iii) a part description, (iv) a part image, (v) design details, (vi) a part geometry, (vii) cost information, (viii) supplier information, (ix) geographic location data, (x) a manufacturing technique, (xi) a manufacturing material, (xii) part availability, (xiii) related bills of material, (xiv) related drawings, and (xv) quality control data.

14. The method of claim 12, wherein the search or analysis request is associated with at least one of: (i) key words, (ii) a search image, (iii) a tree representation of a bill of materials structure, (iv) an adjustment to a prior search or analysis, (v) part profile data information, and (vi) key words in specific fields.

15. The method of claim 12, wherein the evaluation of learning models is associated with a plurality of search or analysis algorithms, including at least one of: (i) a string matching algorithm, (ii) an index algorithm, (iii) a semantic algorithm, (iv) a knowledge base algorithm, (v) a similarity algorithm, (vi) a bill of materials algorithm, (vii) a geometric data algorithm, (viii) a social network data algorithm, (ix) an identity algorithm, (x) a part application algorithm, and (xi) a comparability algorithm.

16. The method of claim 12, wherein a search or analysis algorithm is associated with at least one of: (i) artificial intelligence, (ii) a process clustering, (iii) an associative search, (iv) a cognitive process, (v) machine intelligence, (vi) image recognition, (vii) natural language processing, (viii) an identity search, (ix) a part application search, (x) a comparability search, and (xi) feature extraction.

17. A non-transitory, computer-readable medium storing program code, the program code executable by a computer processor to perform an industrial part modeling method, comprising:
receiving, at an application server platform, information about an industrial part search or analysis request submitted by a user via a user interface;
executing at least one search or analysis algorithm to evaluate learning models in a digital twin industrial part modeling platform, the digital twin industrial part modeling platform containing a plurality of learning models, each learning model describing characteristics of an industrial part available to be incorporated into an industrial asset;
based on said evaluation, arranging to provide an industrial part search or analysis result report to the user via the user interface platform; and
automatically arranging for at least one of a search or analysis algorithm and a learning model to be updated based on interaction with the user.

18. The medium of claim 17, wherein the industrial part search or analysis result report includes at least one of: (i) a customized ranking, (ii) a score, (iii) cost data, (iv) availability data, (v) identical, similar, or comparable parts, (vi) features extraction, and (vii) combined and integrated results from multiple components.

19. The medium of claim 17, wherein the search or analysis algorithm is based at least in part on a user role, including user rolls associated with at least one of: (i) a part requisition role, (ii) design engineer, (iii) expert, (iv) engineering manager, (v) sourcing manager, (vi) service manager, (vii) manufacturing materials manager, (viii) inventory manager, and (ix) a manufacturing role.

20. The medium of claim 17, wherein a rationalization process is executed to combine multiple learning models into a single learning model.

21. The medium of claim 17, wherein the update to the search or analysis algorithm or learning model is based on feedback information received from the user in response to the industrial part search or analysis result report.

22. The medium of claim 21, wherein the feedback information includes at least one of: (i) user comments, (ii) user answers to automatically generated questions, (iii) user buying behavior, (iv) a user vote, (v) user activity information, and (vi) contextual information about users, communities, or networks.
